(19) United States
(12) Patent Application Publication
(10) Pub. No.: US 2022/0050995 A1
(43) Pub. Date: Feb. 17, 2022

(54) PROCESSING SATELLITE IMAGES USING BRAIN EMULATION NEURAL NETWORKS

(71) Applicant: X Development LLC, Mountain View, CA (US)

(72) Inventor: Sarah Ann Laszlo, Mountain View, CA (US)

(21) Appl. No.: 17/401,743

(22) Filed: Aug. 13, 2021

Related U.S. Application Data
(60) Provisional application No. 63/066,083, filed on Aug. 14, 2020.

(51) Int. Cl. G06K 9/00; G06K 9/62; G06K 9/34; G06N 3/02; G06N 3/08

(52) U.S. Cl. CPC G06K 9/0063; G06K 9/6296; G06K 9/6261; G06N 3/08; G06K 9/346; G06N 3/02; G06K 9/628

(57) ABSTRACT

Methods, systems, and apparatus, including computer programs encoded on a computer storage medium, for processing satellite images. In one aspect, a system comprises: a reservoir computing neural network for processing satellite images, wherein the reservoir computing neural network is configured to receive a satellite image and to generate a prediction characterizing the satellite image, wherein the reservoir computing neural network comprises: (i) a brain emulation sub-network, and (ii) an output sub-network, wherein: the brain emulation sub-network has a neural network architecture that is specified by a brain emulation graph, wherein the brain emulation graph is generated based on a synaptic connectivity graph representing synaptic connectivity between neurons in a brain of a biological organism, and the values of at least some of the brain emulation sub-network parameters are determined before the reservoir computing neural network is trained and are not adjusted during training of the reservoir computing neural network.

### CROSS-REFERENCE TO RELATED APPLICATION

This application claims priority under 35 U.S.C. 119 to Provisional Application No. 63/066,083, filed Aug. 14, 2020, which is incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a satellite image processing system implemented as computer programs on one or more computers in one or more locations that processes satellite images using a neural network, referred to herein as a “reservoir computing” neural network, to perform prediction tasks. The reservoir computing neural network includes a sub-network, referred to herein as a “brain emulation” sub-network, which is derived from a synaptic connectivity graph representing synaptic connectivity in the brain of a biological organism. The reservoir computing neural network may be configured to process satellite images to perform any of a variety of prediction tasks, e.g., segmentation tasks, classification tasks, or regression tasks.

A “satellite” refers to a device placed into orbit, e.g., around the Earth. A satellite may be equipped with a camera that enables the satellite to capture images, e.g., of the Earth, that are referred to herein as “satellite images”. For convenience, this specification primarily describes processing satellite images. However, the techniques described herein are not restricted to processing satellite images, but rather, can be used to process any of a variety of types of images. For example, the techniques described herein can be used to process aerial images more generally, e.g., images that are captured from aircraft, drones, or other flying objects. As another example, the techniques described herein can be used to process sonar images of the seafloor.

Throughout this specification, a “neural network” refers to an artificial neural network, i.e., that is implemented by one or more computers. For convenience, a neural network having an architecture derived from a synaptic connectivity graph may be referred to as a “brain emulation” neural network. Identifying an artificial neural network as a “brain emulation” neural network is intended only to conveniently distinguish such neural networks from other neural networks (e.g., with hand-engineered architectures), and should not be interpreted as limiting the nature of the operations that may be performed by the neural network or otherwise implicitly characterizing the neural network.

According to a first aspect there is provided a system comprising one or more computers and one or more storage devices storing instructions that when executed by the one or more computers cause the one or more computers to implement: a reservoir computing neural network for processing satellite images, wherein the reservoir computing neural network is configured to receive a satellite image and to generate a prediction characterizing the satellite image, wherein the reservoir computing neural network comprises: (i) a brain emulation sub-network, and (ii) an output sub-network, wherein: the brain emulation sub-network is configured to process: (i) the satellite image, or (ii) an embedding of the satellite image, in accordance with values of a plurality of brain emulation sub-network parameters to generate an alternative representation of the satellite image; the brain emulation sub-network has a neural network architecture that is specified by a brain emulation graph, wherein the brain emulation graph is generated based on a synaptic connectivity graph representing synaptic connectivity between neurons in a brain of a biological organism, wherein: the synaptic connectivity graph comprises a plurality of nodes and edges, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism; the output sub-network is configured to process the alternative representation of the satellite image in accordance with values of a plurality of output sub-network parameters to generate the prediction characterizing the satellite image; and the values of at least some of the brain emulation sub-network parameters are determined before the reservoir computing neural network is trained and are not adjusted during training of the reservoir computing neural network.

In some implementations, the prediction characterizing the satellite image comprises a segmentation of the satellite image into a plurality of possible categories.

In some implementations, the segmentation of the satellite image into the plurality of possible categories comprises, for each pixel of the satellite image, a respective score for each of the plurality of possible categories, wherein the score for a possible category defines a likelihood that the pixel is included in the possible category.

In some implementations, the plurality of possible categories includes a cloud category, wherein a pixel is included in the cloud category if the pixel is included in a cloud depicted in the satellite image.

In some implementations, the system performs operations further comprising processing the segmentation of the satellite image to remove clouds from the satellite image.

In some implementations, the plurality of possible categories includes a shadow category, wherein a pixel is included in the shadow category if the pixel in included in a shadow depicted in the satellite image.

In some implementations, the system performs operations further comprising processing the segmentation of the satellite image to remove shadows from the satellite image.

In some implementations, the prediction characterizing the satellite image comprises a classification of the satellite image into a plurality of possible classes.

In some implementations, the classification of the satellite image into the plurality of possible classes includes a respective score for each possible class, wherein the score for a possible class defines a likelihood that the satellite image is included in the possible class.

In some implementations, the plurality of possible classes include: (i) a first class indicating that less than a threshold area of the satellite image is occupied by a category of entity, and (ii) a second class indicating that at least the threshold area of the satellite image is occupied by the category of entity.

In some implementations, the category of entity comprises clouds.

In some implementations, the prediction characterizing the satellite image comprises a regression output drawn from a continuous range of possible values.

In some implementations, for each node in the brain emulation graph, the neural network architecture of the brain emulation sub-network includes a respective artificial neuron corresponding to the node; and for each edge in the brain emulation graph, the neural network architecture of the brain emulation sub-network includes a connection between a pair of artificial neurons that correspond to a pair of nodes in the brain emulation graph that are connected by the edge.

In some implementations, the brain emulation graph is generated by applying one or more transformation operations to the synaptic connectivity graph.

In some implementations, the brain emulation graph comprises a sub-graph of the synaptic connectivity graph.

In some implementations, the values of the brain emulation sub-network parameters are determined based on weight values associated with synaptic connections between neurons in the brain of the biological organism.

In some implementations, the values of the plurality of output sub-network parameters are adjusted during the training of the reservoir computing neural network.

In some implementations, the reservoir computing neural network further comprises an input sub-network, wherein the input sub-network is configured to process the satellite image to generate an embedding of the satellite image, wherein the brain emulation sub-network is configured to process the embedding of the satellite image that is generated by the input sub-network.

According to another aspect there is provided system comprising one or more computers and one or more storage devices storing instructions that when executed by the one or more computers cause the one or more computers to perform operations for processing a satellite image using a reservoir computing neural network to generate a prediction characterizing the satellite image, the operations comprising: processing: (i) the satellite image, or (ii) an embedding of the satellite image, using a brain emulation sub-network of the reservoir computing neural network, in accordance with values of a plurality of brain emulation sub-network parameters, to generate an alternative representation of the satellite image, wherein the brain emulation sub-network has a neural network architecture that is specified by a brain emulation graph, wherein the brain emulation graph is generated based on a synaptic connectivity graph representing synaptic connectivity between neurons in a brain of a biological organism, wherein the synaptic connectivity graph comprises a plurality of nodes and edges, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism, wherein the values of at least some of the brain emulation sub-network parameters are determined before the reservoir computing neural network is trained and are not adjusted during training of the reservoir computing neural network; and processing the alternative representation of the satellite image using an output sub-network of the reservoir computing neural network, in accordance with values of a plurality of output sub-network parameters, to generate the prediction characterizing the satellite image.

According to another aspect there are provided one or more non-transitory computer storage media storing instructions that when executed by one or more computers cause the one or more computers to perform the operations of the systems described herein.

According to another aspect there is provided a method performed by one or more data processing apparatus for performing the operations of the systems described herein.

Particular embodiments of the subject matter described in this specification can be implemented so as to realize one or more of the following advantages.

The satellite image processing system described in this specification can process a satellite image using a reservoir computing neural network to generate a prediction characterizing the satellite image, e.g., a pixel-wise segmentation of the satellite image that identifies which pixels of the satellite image are included in clouds. The reservoir computing neural network includes a brain emulation sub-network that is derived from a synaptic connectivity graph representing synaptic connectivity in the brain of a biological organism. The brain of the biological organism may be adapted by evolutionary pressures to be effective at solving certain tasks. For example, in contrast to many conventional computer vision techniques, a biological brain may process visual (image) data to generate a robust representation of the visual data that may be insensitive to factors such as the orientation and size of elements (e.g., objects) characterized by the visual data. The brain emulation sub-network may inherit the capacity of the biological brain to effectively solve tasks (in particular, image processing tasks), and thereby enable the satellite image processing system to perform satellite image processing tasks more effectively, e.g., with higher accuracy.

The satellite image processing system may generate pixel-level segmentations of satellite images, i.e., that can identify each pixel of the satellite image as being included in a respective category. In contrast, a person may manually label the positions of entities (e.g., clouds) in a satellite image, e.g., by drawing a bounding box around the entity. The more precise, pixel-level segmentations generated by the satellite image processing system may facilitate more effective downstream processing of the satellite image segmentations, e.g., to perform de-hazing by removing clouds from the corresponding satellite images.

The brain emulation sub-network of the reservoir computing neural network may have a very large number of parameters and a highly recurrent architecture, i.e., as a result of being derived from a synaptic connectivity graph representing synaptic connectivity in the brain of a biological organism. Therefore, training the brain emulation sub-network using machine learning techniques may be computationally-intensive and prone to failure. Rather than training the brain emulation sub-network, the satellite image processing system may determine the parameter values of the brain emulation sub-network based on the predicted strength of connections between corresponding neurons in the biological brain. The strength of the connection between a pair of neurons in the biological brain may characterize, e.g., the amount of information flow through a synapse connecting the neurons. In this manner, the satellite image processing system may harness the capacity of the brain emulation sub-network, e.g., to generate representations that are effective for processing satellite images, without requiring the brain emulation sub-network to be trained. By refraining from training the brain emulation sub-network, the satellite image processing system may reduce consumption of computational resources, e.g., memory and computing power, during training of the reservoir computing neural network.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example data flow for generating a synaptic connectivity graph representing synaptic connectivity between neurons in the brain of a biological organism.

FIG. 2 shows an example satellite image processing system.

FIG. 3 shows an example of a satellite image and an example of a cloud segmentation of the satellite image.

FIG. 4 shows an example architecture selection system for generating a brain emulation neural network.

FIG. 5 is a flow diagram of an example process for processing a satellite image using a reservoir computing neural network to generate a prediction characterizing the satellite image.

FIG. 6 is a block diagram of an example computer system.

Like reference numbers and designations in the various drawings indicate like elements.

### DETAILED DESCRIPTION

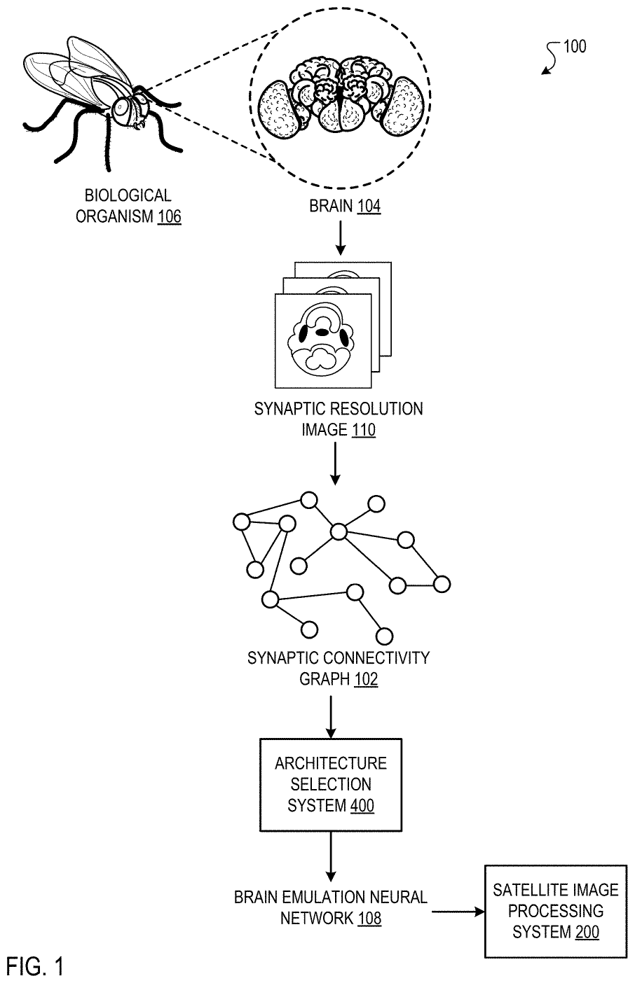

FIG. 1 shows an example data flow 100 for generating a synaptic connectivity graph 102 representing synaptic connectivity between neurons in the brain 104 of a biological organism 106. As used throughout this document, a brain may refer to any amount of nervous tissue from a nervous system of a biological organism, and nervous tissue may refer to any tissue that includes neurons (i.e., nerve cells). The biological organism 106 may be, e.g., a worm, a fly, a mouse, a cat, or a human.

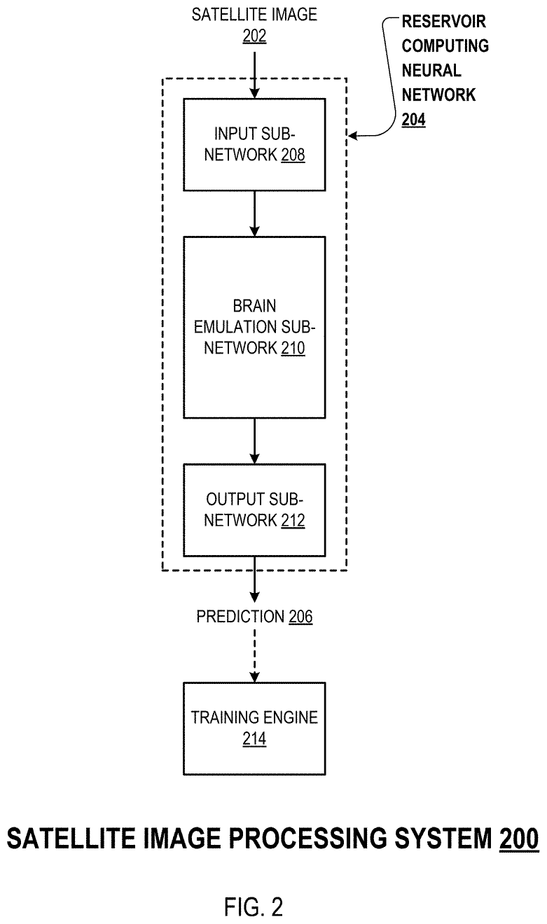

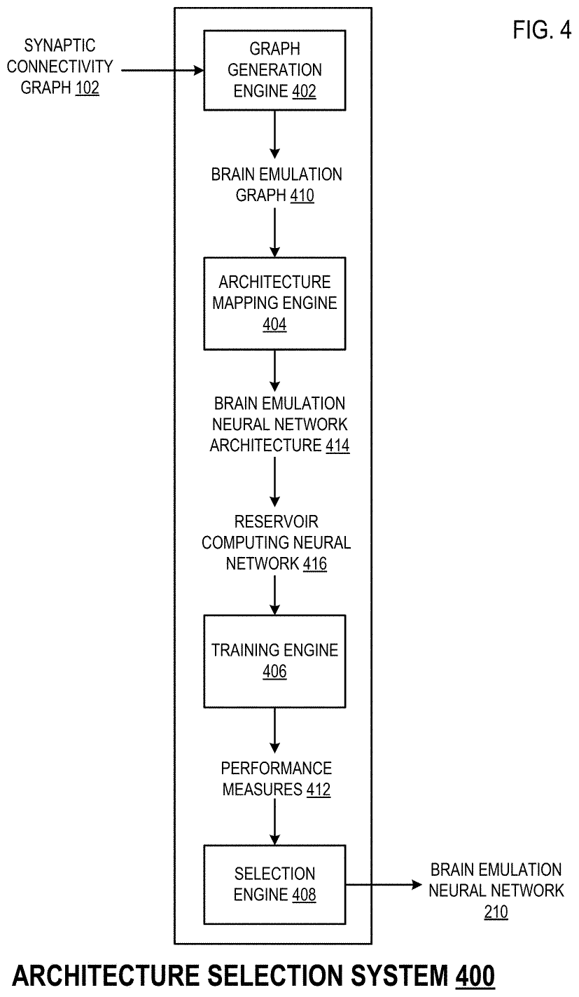

An architecture selection system 400 processes the synaptic connectivity graph 102 to generate a brain emulation neural network 108, and a satellite image processing system 200 uses the brain emulation neural network for processing satellite images. An example satellite image processing system 200 is described in more detail with reference to FIG. 2, and an example architecture selection system 400 is described in more detail with reference to FIG. 4.

An imaging system may be used to generate a synaptic resolution image 110 of the brain 104. An image of the brain 104 may be referred to as having synaptic resolution if it has a spatial resolution that is sufficiently high to enable the identification of at least some synapses in the brain 104. Put another way, an image of the brain 104 may be referred to as having synaptic resolution if it depicts the brain 104 at a magnification level that is sufficiently high to enable the identification of at least some synapses in the brain 104. The image 110 may be a volumetric image, i.e., that characterizes a three-dimensional representation of the brain 104. The image 110 may be represented in any appropriate format, e.g., as a three-dimensional array of numerical values.

The imaging system may be any appropriate system capable of generating synaptic resolution images, e.g., an electron microscopy system. The imaging system may process “thin sections” from the brain 104 (i.e., thin slices of the brain attached to slides) to generate output images that each have a field of view corresponding to a proper subset of a thin section. The imaging system may generate a complete image of each thin section by stitching together the images corresponding to different fields of view of the thin section using any appropriate image stitching technique. The imaging system may generate the volumetric image 110 of the brain by registering and stacking the images of each thin section. Registering two images refers to applying transformation operations (e.g., translation or rotation operations) to one or both of the images to align them. Example techniques for generating a synaptic resolution image of a brain are described with reference to: Z. Zheng, et al., “A complete electron microscopy volume of the brain of adult Drosophila melanogaster,” Cell 174, 730-743 (2018).

A graphing system may be used to process the synaptic resolution image 110 to generate the synaptic connectivity graph 102. The synaptic connectivity graph 102 specifies a set of nodes and a set of edges, such that each edge connects two nodes. To generate the graph 102, the graphing system identifies each neuron in the image 110 as a respective node in the graph, and identifies each synaptic connection between a pair of neurons in the image 110 as an edge between the corresponding pair of nodes in the graph.

The graphing system may identify the neurons and the synapses depicted in the image 110 using any of a variety of techniques. For example, the graphing system may process the image 110 to identify the positions of the neurons depicted in the image 110, and determine whether a synapse connects two neurons based on the proximity of the neurons (as will be described in more detail below). In this example, the graphing system may process an input including: (i) the image, (ii) features derived from the image, or (iii) both, using a machine learning model that is trained using supervised learning techniques to identify neurons in images. The machine learning model may be, e.g., a convolutional neural network model or a random forest model. The output of the machine learning model may include a neuron probability map that specifies a respective probability that each voxel in the image is included in a neuron. The graphing system may identify contiguous clusters of voxels in the neuron probability map as being neurons.

Optionally, prior to identifying the neurons from the neuron probability map, the graphing system may apply one or more filtering operations to the neuron probability map, e.g., with a Gaussian filtering kernel. Filtering the neuron probability map may reduce the amount of “noise” in the neuron probability map, e.g., where only a single voxel in a region is associated with a high likelihood of being a neuron.

The machine learning model used by the graphing system to generate the neuron probability map may be trained using supervised learning training techniques on a set of training data. The training data may include a set of training examples, where each training example specifies: (i) a training input that can be processed by the machine learning model, and (ii) a target output that should be generated by the machine learning model by processing the training input. For example, the training input may be a synaptic resolution image of a brain, and the target output may be a “label map” that specifies a label for each voxel of the image indicating whether the voxel is included in a neuron. The target outputs of the training examples may be generated by manual annotation, e.g., where a person manually specifies which voxels of a training input are included in neurons.

Example techniques for identifying the positions of neurons depicted in the image 110 using neural networks (in particular, flood-filling neural networks) are described with reference to: P. H. Li et al.: “Automated Reconstruction of a Serial-Section EM Drosophila Brain with Flood-Filling Networks and Local Realignment,” bioRxiv doi:10.1101/605634 (2019).

The graphing system may identify the synapses connecting the neurons in the image 110 based on the proximity of the neurons. For example, the graphing system may determine that a first neuron is connected by a synapse to a second neuron based on the area of overlap between: (i) a tolerance region in the image around the first neuron, and (ii) a tolerance region in the image around the second neuron. That is, the graphing system may determine whether the first neuron and the second neuron are connected based on the number of spatial locations (e.g., voxels) that are included in both: (i) the tolerance region around the first neuron, and (ii) the tolerance region around the second neuron. For example, the graphing system may determine that two neurons are connected if the overlap between the tolerance regions around the respective neurons includes at least a predefined number of spatial locations (e.g., one spatial location). A “tolerance region” around a neuron refers to a contiguous region of the image that includes the neuron. For example, the tolerance region around a neuron may be specified as the set of spatial locations in the image that are either: (i) in the interior of the neuron, or (ii) within a predefined distance of the interior of the neuron.

The graphing system may further identify a weight value associated with each edge in the graph 102. For example, the graphing system may identify a weight for an edge connecting two nodes in the graph 102 based on the area of overlap between the tolerance regions around the respective neurons corresponding to the nodes in the image 110. The area of overlap may be measured, e.g., as the number of voxels in the image 110 that are contained in the overlap of the respective tolerance regions around the neurons. The weight for an edge connecting two nodes in the graph 102 may be understood as characterizing the (approximate) strength of the connection between the corresponding neurons in the brain (e.g., the amount of information flow through the synapse connecting the two neurons).

In addition to identifying synapses in the image 110, the graphing system may further determine the direction of each synapse using any appropriate technique. The “direction” of a synapse between two neurons refers to the direction of information flow between the two neurons, e.g., if a first neuron uses a synapse to transmit signals to a second neuron, then the direction of the synapse would point from the first neuron to the second neuron. Example techniques for determining the directions of synapses connecting pairs of neurons are described with reference to: C. Seguin, A. Razi, and A. Zalesky: “Inferring neural signalling directionality from undirected structure connectomes,” Nature Communications 10, 4289 (2019), doi:10.1038/s41467-019-12201-w.

In implementations where the graphing system determines the directions of the synapses in the image 110, the graphing system may associate each edge in the graph 102 with direction of the corresponding synapse. That is, the graph 102 may be a directed graph. In other implementations, the graph 102 may be an undirected graph, i.e., where the edges in the graph are not associated with a direction.

The graph 102 may be represented in any of a variety of ways. For example, the graph 102 may be represented as a two-dimensional array of numerical values, referred to as an “adjacency matrix”, with a number of rows and columns equal to the number of nodes in the graph. The component of the array at position (i, j) may have value 1 if the graph includes an edge pointing from node i to node j, and value 0 otherwise. In implementations where the graphing system determines a weight value for each edge in the graph 102, the weight values may be similarly represented as a two-dimensional array of numerical values. More specifically, if the graph includes an edge connecting node i to node j, the component of the array at position (i, j) may have a value given by the corresponding edge weight, and otherwise the component of the array at position (i, j) may have value 0.

The architecture selection system 400 processes the synaptic connectivity graph 102 to generate a brain emulation neural network 108. The architecture selection system may determine the neural network architecture of the brain emulation neural network by searching a space of possible neural network architectures. The architecture selection system 400 may seed (i.e., initialize) the search through the space of possible neural network architectures using the synaptic connectivity graph 102 representing synaptic connectivity in the brain 104 of the biological organism 106. An example architecture selection system 400 is described in more detail with reference to FIG. 4.

The satellite image processing system 200 uses the brain emulation neural network 108 to process satellite images to generate predictions, as will be described in more detail next.

FIG. 2 shows an example satellite image processing system 200. The satellite image processing system 200 is an example of a system implemented as computer programs on one or more computers in one or more locations in which the systems, components, and techniques described below are implemented.

The system 200 is configured to process a satellite image 202 using a reservoir computing neural network 204 to generate a prediction 206 characterizing the satellite image 202.

The satellite image 202 may be captured using any of a variety of imaging modalities. For example, the satellite image 202 may be a visible light image, an infrared image, or a hyperspectral image. The image 202 may be represented, e.g., as an array of numerical values.

The reservoir computing neural network 204 includes: (i) an input sub-network 208, (ii) a brain emulation sub-network 210, and (iii) an output sub-network 212, each of which will be described in more detail next. Throughout this specification, a “sub-network” refers to a neural network that is included as part of another, larger neural network.

The input sub-network 208 is configured to process the satellite image 202 to generate an embedding of the satellite image 202, i.e., a representation of the satellite image 202 as an ordered collection of numerical values, e.g., a vector or matrix of numerical values. The input sub-network may have any appropriate neural network architecture that enables it to perform its described function, e.g., a neural network architecture that includes a single fully-connected neural network layer.

The brain emulation sub-network 210 is configured to process the embedding of the satellite image 202 (i.e., that is generated by the input sub-network) to generate an alternative representation of the satellite image, e.g., as an ordered collection of numerical values, e.g., a vector or matrix of numerical values. The architecture of the brain emulation sub-network 210 is derived from a synaptic connectivity graph representing synaptic connectivity in the brain of a biological organism. The brain emulation sub-network 210 may be generated, e.g., by an architecture selection system, which will be described in more detail with reference to FIG. 4.

The output sub-network 212 is configured to process the alternative representation of the satellite image (i.e., that is generated by the brain emulation sub-network 210) to generate the prediction 206 characterizing the satellite image 202. The output sub-network 212 may have any appropriate neural network architecture that enables it to perform its described function, e.g., a neural network architecture that includes a single fully-connected layer.

In some cases, the brain emulation sub-network 210 may have a recurrent neural network architecture, i.e., where the connections in the architecture define one or more “loops.” More specifically, the architecture may include a sequence of components (e.g., artificial neurons, layers, or groups of layers) such that the architecture includes a connection from each component in the sequence to the next component, and the first and last components of the sequence are identical. In one example, two artificial neurons that are each directly connected to one another (i.e., where the first neuron provides its output the second neuron, and the second neuron provides its output to the first neuron) would form a recurrent loop.

A recurrent brain emulation sub-network may process a satellite image embedding (i.e., generated by the input sub-network) over multiple (internal) time steps to generate a respective alternative representation of the satellite image at each time step. In particular, at each time step, the brain emulation sub-network may process: (i) the satellite image embedding, and (ii) any outputs generated by the brain emulation sub-network at the preceding time step, to generate the alternative representation of the satellite image for the time step. The reservoir computing neural network 204 may provide the alternative representation of the satellite image generated by the brain emulation sub-network at the final time step as the input to the output sub-network 212. The number of time steps over which the brain emulation sub-network 210 processes the satellite image embedding may be a predetermined hyper-parameter of the satellite image processing system 200.

In addition to processing the alternative representation of the satellite image 202 generated by the output layer of the brain emulation sub-network 210, the output sub-network 212 may additionally process one or more intermediate outputs of the brain emulation sub-network 210. An intermediate output refers to an output generated by a hidden artificial neuron of the brain emulation sub-network, i.e., an artificial neuron that is not included in the input layer or the output layer of the brain emulation sub-network.

The reservoir computing neural network 204 may be configured to generate any of a variety of predictions 206 corresponding to the satellite image 202. A few examples of predictions 206 that may be generated by the reservoir computing neural network 204 are described in more detail next.

In one example, the reservoir computing neural network 204 may be configured to generate a prediction 206 that defines a segmentation of the satellite image 202 into multiple possible categories. The segmentation of the satellite image 202 may include, for each pixel of the satellite image 202, a respective score for each possible category that defines a likelihood that the pixel is included in the possible category. The set of possible categories may include one or more of: a “cloud” category, a “water” category, a “building” category, a “farmland” category, a “livestock” category, a “shadow” category, a “roadway” category, a “smoke” category, a “fire” category, a “desert” category, a “forest” category, and a “default” category (e.g., such that each pixel that is not included in any other category may be understood as being included in the default category).

In another example, the reservoir computing neural network 204 may be configured to generate a prediction 206 that defines a classification of the satellite image 202 into multiple possible classes. The classification of the satellite image may include a respective score for each possible class that defines a likelihood that the satellite image is included in the class. In one example, the possible classes may include: (i) a first class indicating that at least a threshold area of the satellite image is occupied by a certain category of entity, and (ii) a second class indicating that less than a threshold area of the satellite image is occupied by the category of entity. The category of entity may be, e.g., clouds, smoke, building, or water. The threshold area of the satellite image may be, e.g., 10%, 20%, 30%, or any other appropriate threshold area.

In another example, the reservoir computing neural network 204 may be configured to generate a prediction 206 that is drawn from a continuous range of possible values, i.e., the reservoir computing neural network 204 may perform a regression task. For example, the prediction 206 may define a fraction of the area of the satellite image that is occupied by a certain category of entity, e.g., clouds, smoke, building, or water. In this example, the continuous range of possible output values may be, e.g., the range [0,1].

The predictions 206 generated by the reservoir computing neural network 204 can be used for any of a variety of purposes. A few example use cases for the predictions 206 generated by the reservoir computing neural network 204 are described in more detail next.

In one example, the reservoir computing neural network 204 may be configured to generate cloud segmentations of satellite images, i.e., that define whether each pixel of the satellite image is included in a cloud. In this example, a de-hazing system may process: (i) an input satellite image, and (ii) data defining a cloud segmentation of the input satellite image, to generate an output version of the satellite image where any clouds present in the input satellite image have been removed. Examples of de-hazing techniques that may be implemented by the de-hazing system are described in more detail with reference to: J. Long, Z. Shi, W. Tang and C. Zhang, “Single remote sensing image dehazing,” in IEEE Geoscience and Remote Sensing Letters, vol. 11, no. 1, pp. 59-63, January 2014, doi: 10.1109/LGRS.2013.2245857.

In another example, the reservoir computing neural network 204 may be configured to generate shadow segmentations of satellite images, i.e., that define whether each pixel of the satellite image is included in a shadow. In this example, a system may process: (i) an input satellite image, and (ii) data defining a shadow segmentation of the input satellite image, to generate an output version of the satellite image where any shadows present in the input satellite image have been removed. Examples of shadow removal techniques that may be implemented by the system are described in more detail with reference to: Z. Zhu and C. E. Woodcock, “Object-based cloud and cloud shadow detection in Landsat imagery,” in Remote Sensing of Environment, vol. 118, pp. 83-94, March 2012.

In another example, the reservoir computing neural network 204 may be configured to generate a classification that indicates whether at least a threshold area of a satellite image is occupied by clouds. In this example, the classifications generated by the reservoir computing neural network 204 may be used to filter a set of satellite images, e.g., by removing any satellite images where at least the threshold area of the satellite image is occupied by clouds. The remaining satellite images, i.e., where less than the threshold area of the satellite image is occupied by clouds, may then be provided for downstream processing.

In another example, the reservoir computing neural network 204 may be configured to generate segmentations of satellite images into categories that include one or more static landmark categories, i.e., categories corresponding to stationary entities that do not move over time, e.g., roadways or buildings. In this example, the static landmark segmentations generated by the reservoir computing neural network may be used to register (i.e., align) satellite images. More specifically, to register two satellite image having overlapping fields of view, the reservoir computing neural network may process each satellite image to generate a respective static landmark segmentation of each satellite image, e.g., a segmentation of the respective roadways depicted in each satellite image. The respective static landmark segmentation of each satellite image may be provided to an optimization system that determines the parameters of a transformation (e.g., an affine or elastic transformation) that (approximately or exactly) aligns the static landmark segmentations of the satellite images. For example, the optimization system may use a black-box optimization technique to determine the parameters of a transformation that maximizes the overlap of the static landmark segmentations. After determining the parameters of the transformation that aligns the static landmark segmentations of the satellite images, the same transformation may be applied to the original satellite images to (approximately or exactly) align the original satellite images.

In another example, the reservoir computing neural network 204 may be configured to generate segmentations of water shown in satellite images. In one example, water segmentations generated by the reservoir computing neural network may be used to determine the extent of flooding, e.g., by determining the area of a region covered by floodwater. In another example, water segmentations generated by the reservoir computing system may be processed by a prediction system to predict the likelihood of flooding occurring in an area over a future time interval, e.g., in the next day, next week, or next month.

In another example, the reservoir computing neural network 204 may be configured to generate segmentations of smoke and/or fire shown in satellite images. The smoke/fire segmentations may be used to determine a risk to people or buildings in the vicinity of the smoke/fire.

The satellite image processing system 200 may use a training engine 214 to train the reservoir computing neural network 204, i.e., to enable the reservoir computing neural network 204 to generate accurate predictions. The training engine 214 may train the reservoir computing neural network 204 on a set of training data that includes multiple training examples, where each training example specifies: (i) a satellite image, and (ii) a target prediction corresponding to the satellite image. The target prediction corresponding to the satellite image defines the prediction that should be generated by the reservoir computing neural network 204 by processing the satellite image.

At each of multiple training iterations, the training engine 214 may sample a batch (i.e., set) of training examples from the training data, and process the respective satellite image included in each training example using the reservoir computing neural network 204 to generate a corresponding prediction. The training engine 214 may determine gradients of an objective function with respect to the reservoir computing neural network parameters, where the objective function measures an error between: (i) the predictions generated by the reservoir computing neural network, and (ii) the target predictions specified by the training examples. The training engine 214 may use the gradients of the objective function to update the values of the reservoir computing neural network parameters, e.g., to reduce the error measured by the objective function. The error may be, e.g., a cross-entropy error, a squared-error, or any other appropriate error. The training engine 214 may determine the gradients of the objective function with respect to the reservoir computing neural network parameters, e.g., using backpropagation techniques. The training engine 214 may use the gradients to update the reservoir computing neural network parameters using the update rule of a gradient descent optimization algorithm, e.g., Adam or RMSprop.

During training of the reservoir computing neural network 204, the parameter values of the input sub-network 208 and the output sub-network 212 are trained, but some or all of the parameter values of the brain emulation sub-network 210 may be static, i.e., not trained. Instead of being trained, the parameter values of the brain emulation sub-network 210 may be determined from the weight values of the edges of the synaptic connectivity graph, as will be described in more detail below with reference to FIG. 4. Generally, the brain emulation sub-network may have a large number of parameters and a highly recurrent architecture as a result of being derived from the synaptic connectivity of a biological brain. Therefore training the brain emulation sub-network may be computationally-intensive and prone to failure, e.g., as a result of the parameter values of the brain emulation sub-network oscillating or diverging rather than converging to fixed values. The reservoir computing neural network 204 may harness the capacity of the brain emulation sub-network, e.g., to generate representations that are effective for processing satellite images, without requiring the brain emulation sub-network to be trained.

The training engine 214 may use any of a variety of regularization techniques during training of the reservoir computing neural network 204. For example, the training engine 214 may use a dropout regularization technique, such that certain artificial neurons of the brain emulation sub-network are “dropped out” (e.g., by having their output set to zero) with a non-zero probability p>0 each time the brain emulation sub-network processes an input. Using the dropout regularization technique may improve the performance of the trained reservoir computing neural network 204, e.g., by reducing the likelihood of over-fitting. An example dropout regularization technique is described with reference to: N. Srivastava, et al.: “Dropout: a simple way to prevent neural networks from overfitting,” Journal of Machine Learning Research 15 (2014) 1929-1958. As another example, the training engine 214 may regularize the training of the reservoir computing neural network 204 by including a “penalty” term in the objective function that measures the magnitude of the parameter values of the input sub-network 208, the output sub-network 212, or both. The penalty term may be, e.g., an L₁ or L₂ norm of the parameter values of the input sub-network 208, the output sub-network 212, or both.

In some cases, the values of the intermediate outputs of the brain emulation sub-network 210 may have large magnitudes, e.g., as a result of the parameter values of the brain emulation sub-network 210 being derived from the weight values of the edges of the synaptic connectivity graph rather than being trained. Therefore, to facilitate training of the reservoir computing neural network 204, batch normalization layers may be included between the layers of the brain emulation sub-network 210, which can contribute to limiting the magnitudes of intermediate outputs generated by the brain emulation sub-network. Alternatively or in combination, the activation functions of the neurons of the brain emulation sub-network may be selected to have a limited range. For example, the activation functions of the neurons of the brain emulation sub-network may be selected to be sigmoid activation functions with range given by [0,1].

The example architecture of the reservoir computing neural network that is described with reference to FIG. 2 is provided for illustrative purposes only, and other architectures of the reservoir computing neural network are possible. For example, the reservoir computing neural network may include a sequence of multiple different brain emulation sub-networks, e.g., each generated by the architecture selection system described with reference to FIG. 4. In this example, the brain emulation sub-networks may be interleaved with sub-networks having parameter values that are trained during the training of the reservoir computing neural network, i.e., in contrast to the parameter values of the brain emulation sub-networks. Generally, a reservoir computing neural network 204 includes: (i) one or more brain emulation sub-networks having parameter values derived from a synaptic connectivity graph, and (ii) one or more trainable sub-networks. The brain emulation sub-networks and the trainable sub-networks may be connected in any of a variety of configurations.

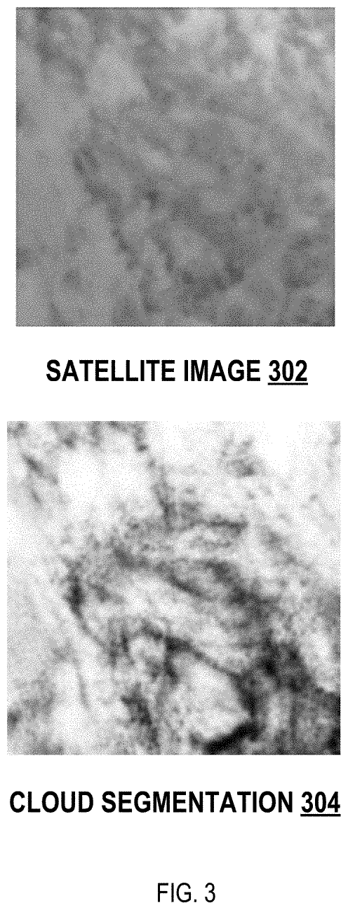

FIG. 3 shows an example of a satellite image 302, and an example of a cloud segmentation 304 of the satellite image 302 that may be generated by the reservoir computing neural network described with reference to FIG. 2. The reservoir computing neural network may generate a cloud segmentation that defines, for each pixel in a satellite image, a score that indicates a likelihood that the pixel is included in a cloud. In the illustration of the cloud segmentation 304, the intensity of each pixel is defined by the likelihood of the pixel being included in a cloud, i.e., such that lighter-colored pixels are more likely to be included in a cloud.

FIG. 4 shows an example architecture selection system 400. The architecture selection system 400 is an example of a system implemented as computer programs on one or more computers in one or more locations in which the systems, components, and techniques described below are implemented.

The system 400 is configured to search a space of possible neural network architectures to identify the neural network architecture of a brain emulation neural network 108 to be included in a reservoir computing neural network that processes satellite images, e.g., as described with reference to FIG. 2. The system 400 seeds the search through the space of possible neural network architectures using a synaptic connectivity graph 102 representing synaptic connectivity in the brain of a biological organism. The synaptic connectivity graph 102 may be derived directly from a synaptic resolution image of the brain of a biological organism, e.g., as described with reference to FIG. 1. In some cases, the synaptic connectivity graph 102 may be a sub-graph of a larger graph derived from a synaptic resolution image of a brain, e.g., a sub-graph that includes neurons of a particular type, e.g., visual neurons.

The system 400 includes a graph generation engine 402, an architecture mapping engine 404, a training engine 406, and a selection engine 408, each of which will be described in more detail next.

The graph generation engine 402 is configured to process the synaptic connectivity graph 102 to generate multiple “brain emulation” graphs 410, where each brain emulation graph is defined by a set of nodes and a set of edges, such that each edge connects a pair of nodes. The graph generation engine 402 may generate the brain emulation graphs 410 from the synaptic connectivity graph 102 using any of a variety of techniques. A few examples follow.

In one example, the graph generation engine 402 may generate a brain emulation graph 410 at each of multiple iterations by processing the synaptic connectivity graph 102 in accordance with current values of a set of graph generation parameters. The current values of the graph generation parameters may specify (transformation) operations to be applied to an adjacency matrix representing the synaptic connectivity graph 102 to generate an adjacency matrix representing a brain emulation graph 410. The operations to be applied to the adjacency matrix representing the synaptic connectivity graph may include, e.g., filtering operations, cropping operations, or both. The brain emulation graph 410 may be defined by the result of applying the operations specified by the current values of the graph generation parameters to the adjacency matrix representing the synaptic connectivity graph 102.

The graph generation engine 402 may apply a filtering operation to the adjacency matrix representing the synaptic connectivity graph 102, e.g., by convolving a filtering kernel with the adjacency matrix representing the synaptic connectivity graph. The filtering kernel may be defined by a two-dimensional matrix, where the components of the matrix are specified by the graph generation parameters. Applying a filtering operation to the adjacency matrix representing the synaptic connectivity graph 102 may have the effect of adding edges to the synaptic connectivity graph 102, removing edges from the synaptic connectivity graph 102, or both.

The graph generation engine 402 may apply a cropping operation to the adjacency matrix representing the synaptic connectivity graph 102, where the cropping operation replaces the adjacency matrix representing the synaptic connectivity graph 102 with an adjacency matrix representing a sub-graph of the synaptic connectivity graph 102. The cropping operation may specify a sub-graph of synaptic connectivity graph 102, e.g., by specifying a proper subset of the rows and a proper subset of the columns of the adjacency matrix representing the synaptic connectivity graph 102 that define a sub-matrix of the adjacency matrix. The sub-graph may include: (i) each edge specified by the sub-matrix, and (ii) each node that is connected by an edge specified by the sub-matrix.

At each iteration, the system 400 determines a performance measure 412 corresponding to the brain emulation graph 410 generated at the iteration, and the system 400 updates the current values of the graph generation parameters to encourage the generation of brain emulation graphs 410 with higher performance measures 412. The performance measure 412 for a brain emulation graph 410 characterizes the performance of a reservoir computing neural network that includes a brain emulation neural network having an architecture specified by the brain emulation graph 410 at processing satellite images to perform a task. Determining performance measures 412 for brain emulation graphs 410 will be described in more detail below. The system 400 may use any appropriate optimization technique to update the current values of the graph generation parameters, e.g., a “black-box” optimization technique that does not rely on computing gradients of the operations performed by the graph generation engine 402. Examples of black-box optimization techniques which may be implemented by the optimization engine are described with reference to: Golovin, D., Solnik, B., Moitra, S., Kochanski, G., Karro, J., & Sculley, D.: “Google vizier: A service for black-box optimization,” In Proceedings of the 23rd ACM SIGKDD International Conference on Knowledge Discovery and Data Mining, pp. 1487-1495 (2017). Prior to the first iteration, the values of the graph generation parameters may be set to default values or randomly initialized.

In another example, the graph generation engine 402 may generate the brain emulation graphs 410 by “evolving” a population (i.e., a set) of graphs derived from the synaptic connectivity graph 102 over multiple iterations. The graph generation engine 402 may initialize the population of graphs, e.g., by “mutating” multiple copies of the synaptic connectivity graph 102. Mutating a graph refers to making a random change to the graph, e.g., by randomly adding or removing edges or nodes from the graph. After initializing the population of graphs, the graph generation engine 402 may generate a brain emulation graph at each of multiple iterations by, at each iteration, selecting a graph from the population of graphs derived from the synaptic connectivity graph and mutating the selected graph to generate a brain emulation graph 410. The graph generation engine 402 may determine a performance measure 412 for the brain emulation graph 410, and use the performance measure to determine whether the brain emulation graph 410 is added to the current population of graphs.

In some implementations, each edge of the synaptic connectivity graph may be associated with a weight value that is determined from the synaptic resolution image of the brain, as described above. Each brain emulation graph may inherit the weight values associated with the edges of the synaptic connectivity graph. For example, each edge in the brain emulation graph that corresponds to an edge in the synaptic connectivity graph may be associated with the same weight value as the corresponding edge in the synaptic connectivity graph. Edges in the brain emulation graph that do not correspond to edges in the synaptic connectivity graph may be associated with default or randomly initialized weight values.

The architecture mapping engine 404 processes each brain emulation graph 410 to generate a corresponding brain emulation neural network architecture 414. The architecture mapping engine 404 may use the brain emulation graph 410 derived from the synaptic connectivity graph 102 to specify the brain emulation neural network architecture 414 in any of a variety of ways. For example, the architecture mapping engine may map each node in the brain emulation graph 410 to a corresponding: (i) artificial neuron, (ii) artificial neural network layer, or (iii) group of artificial neural network layers in the brain emulation neural network architecture, as will be described in more detail next.

In one example, the brain emulation neural network architecture may include: (i) a respective artificial neuron corresponding to each node in the brain emulation graph 410, and (ii) a respective connection corresponding to each edge in the brain emulation graph 410. In this example, the brain emulation graph may be a directed graph, and an edge that points from a first node to a second node in the brain emulation graph may specify a connection pointing from a corresponding first artificial neuron to a corresponding second artificial neuron in the brain emulation neural network architecture. The connection pointing from the first artificial neuron to the second artificial neuron may indicate that the output of the first artificial neuron should be provided as an input to the second artificial neuron. Each connection in the brain emulation neural network architecture may be associated with a weight value, e.g., that is specified by the weight value associated with the corresponding edge in the brain emulation graph. An artificial neuron may refer to a component of the brain emulation neural network architecture that is configured to receive one or more inputs (e.g., from one or more other artificial neurons), and to process the inputs to generate an output. The inputs to an artificial neuron and the output generated by the artificial neuron may be represented as scalar numerical values. In one example, a given artificial neuron may generate an output b as:

$$b = σ ( {\sum }_{i = 1}^{n} {w}_{i} \cdot {a}_{i} ) \qquad ( 1 )$$

where σ(⋅) is a non-linear “activation” function (e.g., a sigmoid function or an arctangent function), {aᵢ}ᵢ₌₁ⁿ are the inputs provided to the given artificial neuron, and {wᵢ}ᵢ₌₁ⁿ are the weight values associated with the connections between the given artificial neuron and each of the other artificial neurons that provide an input to the given artificial neuron.

In another example, the brain emulation graph 410 may be an undirected graph, and the architecture mapping engine 404 may map an edge that connects a first node to a second node in the brain emulation graph 410 to two connections between a corresponding first artificial neuron and a corresponding second artificial neuron in the brain emulation neural network architecture. In particular, the architecture mapping engine 404 may map the edge to: (i) a first connection pointing from the first artificial neuron to the second artificial neuron, and (ii) a second connection pointing from the second artificial neuron to the first artificial neuron.

In another example, the brain emulation graph 410 may be an undirected graph, and the architecture mapping engine may map an edge that connects a first node to a second node in the brain emulation graph 410 to one connection between a corresponding first artificial neuron and a corresponding second artificial neuron in the brain emulation neural network architecture. The architecture mapping engine may determine the direction of the connection between the first artificial neuron and the second artificial neuron, e.g., by randomly sampling the direction in accordance with a probability distribution over the set of two possible directions.

In another example, the brain emulation neural network architecture may include: (i) a respective artificial neural network layer corresponding to each node in the brain emulation graph 410, and (ii) a respective connection corresponding to each edge in the brain emulation graph 410. In this example, a connection pointing from a first layer to a second layer may indicate that the output of the first layer should be provided as an input to the second layer. An artificial neural network layer may refer to a collection of artificial neurons, and the inputs to a layer and the output generated by the layer may be represented as ordered collections of numerical values (e.g., tensors of numerical values). In one example, the brain emulation neural network architecture may include a respective convolutional neural network layer corresponding to each node in the brain emulation graph 410, and each given convolutional layer may generate an output d as:

$$d = σ ( {h}_{θ} ( {\sum }_{i = 1}^{n} {w}_{i} \cdot {c}_{i} ) ) \qquad ( 2 )$$

where each cᵢ (i=1, . . . , n) is a tensor (e.g., a two- or three-dimensional array) of numerical values provided as an input to the layer, each wᵢ (i=1, . . . , n) is a weight value associated with the connection between the given layer and each of the other layers that provide an input to the given layer (where the weight value for each connection may be specified by the weight value associated with the corresponding edge in the brain emulation graph), h_{θ}(⋅) represents the operation of applying one or more convolutional kernels to an input to generate a corresponding output, and σ(⋅) is a non-linear activation function that is applied element-wise to each component of its input. In this example, each convolutional kernel may be represented as an array of numerical values, e.g., where each component of the array is randomly sampled from a predetermined probability distribution, e.g., a standard Normal probability distribution.

In another example, the architecture mapping engine may determine that the brain emulation neural network architecture includes: (i) a respective group of artificial neural network layers corresponding to each node in the brain emulation graph 410, and (ii) a respective connection corresponding to each edge in the brain emulation graph 410. The layers in a group of artificial neural network layers corresponding to a node in the brain emulation graph 410 may be connected, e.g., as a linear sequence of layers, or in any other appropriate manner.

For each brain emulation neural network architecture 414, the training engine 406 instantiates a reservoir computing neural network 416 that includes a brain emulation sub-network having the brain emulation neural network architecture 414. Examples of reservoir computing neural networks that include brain emulation sub-networks are described in more detail with reference to FIG. 2. Each reservoir computing neural network 416 is configured to perform a satellite image processing task, e.g., a prediction task or an auto-encoding task. In a prediction task, the reservoir computing neural network is configured to process a satellite image to generate a prediction characterizing the satellite image, e.g., a segmentation, classification, or regression prediction, as described above. In an auto-encoding task, the reservoir computing neural network is configured to process a satellite image to generate a “reconstruction” (i.e., estimate) of the satellite image.

The training engine 406 is configured to train each reservoir computing neural network 416 to perform a satellite image processing task over multiple training iterations. Training a reservoir computing neural network that includes a brain emulation sub-network to perform a prediction task is described with reference to FIG. 2. Training a reservoir computing neural network to perform an auto-encoding task proceeds similarly, except that the objective function being optimized measures an error between: (i) a satellite image, and (ii) a reconstruction of the satellite image that is generated by the reservoir computing neural network.

The training engine 406 determines a respective performance measure 412 of each reservoir computing neural network 416 on the satellite image processing task. For example, to determine the performance measure, the training engine 406 may obtain a “validation” set of satellite images that were not used during training of the reservoir computing neural network, and process each of these satellite images using the trained reservoir computing neural network to generate a corresponding output. The training engine 406 may then determine the performance measure 412 based on the respective error between: (i) the output generated by the reservoir computing neural network for the satellite image, and (ii) a target output for the satellite image, for each satellite image in the validation set. For a prediction task, the target output for a satellite image may be, e.g., a ground-truth segmentation, classification, or regression output. For an auto-encoding task, the target output for a satellite image may be the satellite image itself. The training engine 406 may determine the performance measure 412, e.g., as the average error or the maximum error over the satellite images in the validation set.

The selection engine 408 uses the performance measures 412 to generate the output brain emulation neural network 108. In one example, the selection engine 408 may generate a brain emulation neural network 108 having the brain emulation neural network architecture 414 associated with the best (e.g., highest) performance measure 412.

If the performance measures 412 characterize the performance of the reservoir computing neural networks 416 on a prediction task, then the architecture selection system 400 may generate a brain emulation neural network 108 that is tuned for effective performance on the specific prediction task. If, on the other hand, the performance measures 412 characterize the performance of the reservoir computing neural networks 416 on an auto-encoding task, then the architecture selection system 400 may generate a brain emulation neural network 108 that is generally effective for a variety of prediction tasks that involve processing satellite images.

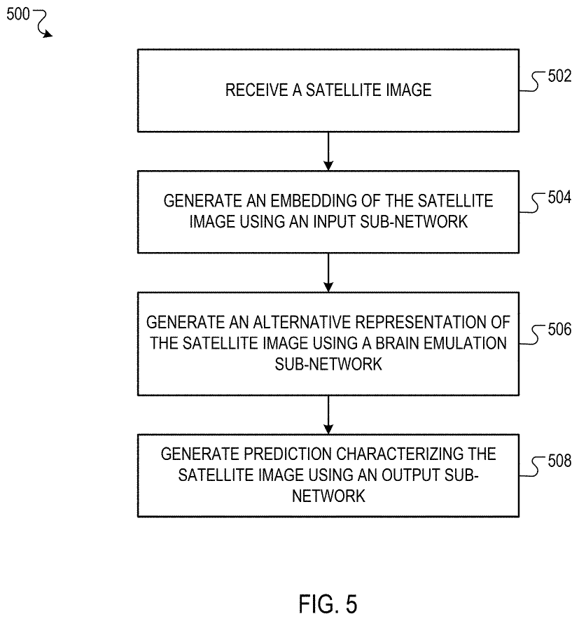

FIG. 5 is a flow diagram of an example process 500 for processing a satellite image using a reservoir computing neural network to generate a prediction characterizing the satellite image. For convenience, the process 500 will be described as being performed by a system of one or more computers located in one or more locations. For example, a satellite image processing system, e.g., the satellite image processing system 200 of FIG. 2, appropriately programmed in accordance with this specification, can perform the process 500.

The system receives a satellite image (502).

The system processes the satellite image using an input sub-network of the reservoir computing neural network to generate an embedding of the satellite image (504).

The system processes the embedding of the satellite image using a brain emulation sub-network of the reservoir computing neural network to generate an alternative representation of the satellite image (504). The values of at least some of the brain emulation sub-network parameters may be determined before the reservoir computing neural network is trained and not be adjusted during training of the reservoir computing neural network. The brain emulation sub-network has a neural network architecture that is specified by a brain emulation graph, where the brain emulation graph is generated based on a synaptic connectivity graph representing synaptic connectivity between neurons in a brain of a biological organism. The synaptic connectivity graph specifies a set of nodes and a set of edges, where each edge connects a pair of nodes, each node corresponds to a respective neuron in the brain of the biological organism. Each edge connecting a pair of nodes in the synaptic connectivity graph may correspond to a synaptic connection between a pair of neurons in the brain of the biological organism.

The system processes the alternative representation of the satellite image using an output sub-network of the reservoir computing neural network to generate a prediction characterizing the satellite image (508). The prediction may be, e.g., a cloud segmentation of the satellite image that defines, for each pixel of the satellite image, a respective likelihood that the pixel is included in a cloud depicted in the satellite image.

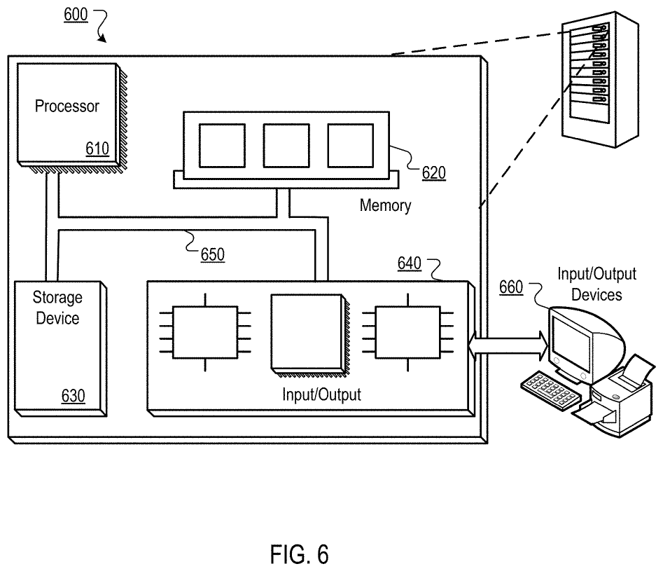

FIG. 6 is a block diagram of an example computer system 600 that can be used to perform operations described previously. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (for example, a cloud storage device), or some other large capacity storage device.

The input/output device 640 provides input/output operations for the system 600. In one implementation, the input/output device 640 can include one or more network interface devices, for example, an Ethernet card, a serial communication device, for example, and RS-232 port, and/or a wireless interface device, for example, and 802.11 card. In another implementation, the input/output device 640 can include driver devices configured to receive input data and send output data to other input/output devices, for example, keyboard, printer and display devices 660. Other implementations, however, can also be used, such as mobile computing devices, mobile communication devices, and set-top box television client devices.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising one or more computers and one or more storage devices storing instructions that when executed by the one or more computers cause the one or more computers to implement:
a reservoir computing neural network for processing satellite images, wherein the reservoir computing neural network is configured to receive a satellite image and to generate a prediction characterizing the satellite image, wherein the reservoir computing neural network comprises: (i) a brain emulation sub-network, and (ii) an output sub-network, wherein:
the brain emulation sub-network is configured to process: (i) the satellite image, or (ii) an embedding of the satellite image, in accordance with values of a plurality of brain emulation sub-network parameters to generate an alternative representation of the satellite image;
the brain emulation sub-network has a neural network architecture that is specified by a brain emulation graph, wherein the brain emulation graph is generated based on a synaptic connectivity graph representing synaptic connectivity between neurons in a brain of a biological organism, wherein:
the synaptic connectivity graph comprises a plurality of nodes and edges, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism;
the output sub-network is configured to process the alternative representation of the satellite image in accordance with values of a plurality of output sub-network parameters to generate the prediction characterizing the satellite image; and
the values of at least some of the brain emulation sub-network parameters are determined before the reservoir computing neural network is trained and are not adjusted during training of the reservoir computing neural network.

2. The system of claim 1, wherein the prediction characterizing the satellite image comprises a segmentation of the satellite image into a plurality of possible categories.

3. The system of claim 2, wherein the segmentation of the satellite image into the plurality of possible categories comprises, for each pixel of the satellite image, a respective score for each of the plurality of possible categories, wherein the score for a possible category defines a likelihood that the pixel is included in the possible category.

4. The system of claim 3, wherein the plurality of possible categories includes a cloud category, wherein a pixel is included in the cloud category if the pixel is included in a cloud depicted in the satellite image.

5. The system of claim 4, further comprising processing the segmentation of the satellite image to remove clouds from the satellite image.

6. The system of claim 3, wherein the plurality of possible categories includes a shadow category, wherein a pixel is included in the shadow category if the pixel in included in a shadow depicted in the satellite image.

7. The system of claim 6, further comprising processing the segmentation of the satellite image to remove shadows from the satellite image.

8. The system of claim 1, wherein the prediction characterizing the satellite image comprises a classification of the satellite image into a plurality of possible classes.

9. The system of claim 8, wherein the classification of the satellite image into the plurality of possible classes includes a respective score for each possible class, wherein the score for a possible class defines a likelihood that the satellite image is included in the possible class.

10. The system of claim 9, wherein the plurality of possible classes include: (i) a first class indicating that less than a threshold area of the satellite image is occupied by a category of entity, and (ii) a second class indicating that at least the threshold area of the satellite image is occupied by the category of entity.

11. The system of claim 10, wherein the category of entity comprises clouds.

12. The system of claim 1, wherein the prediction characterizing the satellite image comprises a regression output drawn from a continuous range of possible values.

13. The system of claim 1, wherein:
for each node in the brain emulation graph, the neural network architecture of the brain emulation sub-network includes a respective artificial neuron corresponding to the node; and
for each edge in the brain emulation graph, the neural network architecture of the brain emulation sub-network includes a connection between a pair of artificial neurons that correspond to a pair of nodes in the brain emulation graph that are connected by the edge.

14. The system of claim 1, wherein the brain emulation graph is generated by applying one or more transformation operations to the synaptic connectivity graph.

15. The system of claim 1, wherein the brain emulation graph comprises a sub-graph of the synaptic connectivity graph.

16. The system of claim 1, wherein the values of the brain emulation sub-network parameters are determined based on weight values associated with synaptic connections between neurons in the brain of the biological organism.

17. The system of claim 1, the values of the plurality of output sub-network parameters are adjusted during the training of the reservoir computing neural network.

18. The system of claim 1, wherein the reservoir computing neural network further comprises an input sub-network, wherein the input sub-network is configured to process the satellite image to generate an embedding of the satellite image, wherein the brain emulation sub-network is configured to process the embedding of the satellite image that is generated by the input sub-network.

19. A method performed by one or more data processing apparatus for processing a satellite image using a reservoir computing neural network to generate a prediction characterizing the satellite image, the method comprising:
processing: (i) the satellite image, or (ii) an embedding of the satellite image, using a brain emulation sub-network of the reservoir computing neural network, in accordance with values of a plurality of brain emulation sub-network parameters, to generate an alternative representation of the satellite image,
wherein the brain emulation sub-network has a neural network architecture that is specified by a brain emulation graph, wherein the brain emulation graph is generated based on a synaptic connectivity graph representing synaptic connectivity between neurons in a brain of a biological organism,
wherein the synaptic connectivity graph comprises a plurality of nodes and edges, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism,
wherein the values of at least some of the brain emulation sub-network parameters are determined before the reservoir computing neural network is trained and are not adjusted during training of the reservoir computing neural network; and
processing the alternative representation of the satellite image using an output sub-network of the reservoir computing neural network, in accordance with values of a plurality of output sub-network parameters, to generate the prediction characterizing the satellite image.

20. A system comprising one or more computers and one or more storage devices storing instructions that when executed by the one or more computers cause the one or more computers to implement a reservoir computing neural network for processing satellite images, wherein the reservoir computing neural network is configured perform operations comprising:
receiving an satellite image;
processing the satellite image using an input sub-network having a plurality of input sub-network parameters to generate an embedding of the satellite image;
processing the embedding of the satellite image using a brain emulation sub-network having a plurality of brain emulation sub-network parameters to generate an alternative representation of the satellite image,
wherein the values of at least some of the brain emulation sub-network parameters are determined before the reservoir computing neural network is trained and are not adjusted during training of the reservoir computing neural network,
wherein the brain emulation sub-network has a neural network architecture that is specified by a brain emulation graph, wherein the brain emulation graph is generated based on a synaptic connectivity graph representing synaptic connectivity between neurons in a brain of a biological organism,
wherein the synaptic connectivity graph comprises a plurality of nodes and edges, wherein each edge connects a pair of nodes, each node corresponds to a respective neuron in the brain of the biological organism, and each edge connecting a pair of nodes in the synaptic connectivity graph corresponds to a synaptic connection between a pair of neurons in the brain of the biological organism; and
processing the alternative representation of the satellite image using an output sub-network having a plurality of output sub-network parameters to generate a cloud segmentation of the satellite image that defines, for each pixel of the satellite image, a respective likelihood that the pixel is included in a cloud depicted in the satellite image.
